(19) United States
(12) Patent Application Publication
(10) Pub. No.: US 2005/0058523 A1
(43) Pub. Date: Mar. 17, 2005

(54) Assembled structure and bolt structure, connecting device thereof

(75) Inventors: Shan-Yan Yang, Banciao (TW); Jian-Bo Gu, Jiangsu (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/920,542

(22) Filed: Aug. 18, 2004

(30) Foreign Application Priority Data
Sep. 17, 2003 (TW) TW92125581

(51) Int. Cl. F16B 1/00

(52) U.S. Cl. 411/187

(57) ABSTRACT

A bolt structure or a connecting device. The bolt structure connects a first object to a second object to. form an assembled structure. The connecting device comprises a main portion having a base surface, a second portion disposed on the main portion, and a plurality of cantilever portions extending from the base surface, respectively. The second portion of the connecting device includes a screw region. When fastening the connecting device from the first object to the second object, the first object and the second object are connected to form the assembled structure, and the cantilever portions flexibly and uniformly contact the outer surface of the first object.

### BACKGROUND

The present invention relates to a connecting device and a bolt structure, and in particular to an assembled structure connected by a bolt structure or connecting device preventing loosening due to vibration.

FIG. 1A is a plane view of the structure of two overlapping objects 10 and 11 connected to each other by a conventional bolt 20, and FIG. 1B is a view of the structure of the bolt 20 in FIG. 1A. The object 10 can be a base plate for fixing, and the object 11 can be an electronic device.

In FIG. 1B, the bolt 20 has a head 21 and a threaded rod 32 extending from the center of the bottom surface of the head 21.

When fastening the bolt 20 from the object 10 to the object 11, the threaded rod 32 of the bolt 20 passes through the objects 10 and 11, and finally the bottom surface of the head 21 of the bolt 20 contacts on the object 10. Thus, the object 10 and the object 11 are connected to each other.

Due to the planar surface of the head 21 of the bolt 20, the bolt 20 may possibly loosen due to vibration, i.e., the assembled objects 10 and 11 are easily separated by vibration or unexpected collision.

For example, in a high frequency and directional vibration environment, the bolt 20 is loosened by an acting force generated from vibration as the acting force is larger than a predetermined frictional force between the bottom surface of the head 21 and the object 10.

### SUMMARY

Accordingly, an object of the invention is to provide an assembled object or structure with a bolt structure or a connecting device to increase bonding force therebetween, especially for a high frequency and directional vibration environment.

The invention provides a bolt structure or a connecting device for connecting a first object to a second object to form an assembled structure. The connecting device has a first main body, a second main body and a plurality of cantilevered portions. The first main body has a base surface, and the second main body is disposed on the base surface of the first main body for fastening the first object to the second object. The cantilevered portions are disposed on the first main body and extend a predetermined distance from the base surface of the first main body. The second main body has a threaded portion helically extending along a direction opposite to the direction of the cantilevered portions, and the spaced cantilevered portions extend from the base surface of the first main body.

As the second main body of the connecting device sequentially fastens the first object and the second object, the first object and the second object are connected to each other and the cantilevered portions of the connecting device uniformly contact the first object. Each distal end of the cantilevered portion is substantially embedded on the surface of the first object preventing the connecting device from rotating under vibration.

The connecting device is made of metal or plastic, and the cantilevered portion is harder than the first object or contact thereof. The first main body, the second main body and the cantilevered portions are integrally formed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a plane view of the structure of two overlapping plates (10 and 11) connected by a conventional bolt (20);

FIG. 1B is a schematic view of the structure of the conventional bolt (20) in FIG. 1A;

FIG. 2 is a perspective view of an assembled structure (K) of the invention;

FIG. 3 is a perspective view of a bolt structure or a connecting device (30) of FIG. 2;

FIG. 4A is a side view of the bolt structure or a connecting device (30) of FIG. 3; and

FIG. 4B is a top view of the bolt structure or a connecting device (30) of FIG. 3.

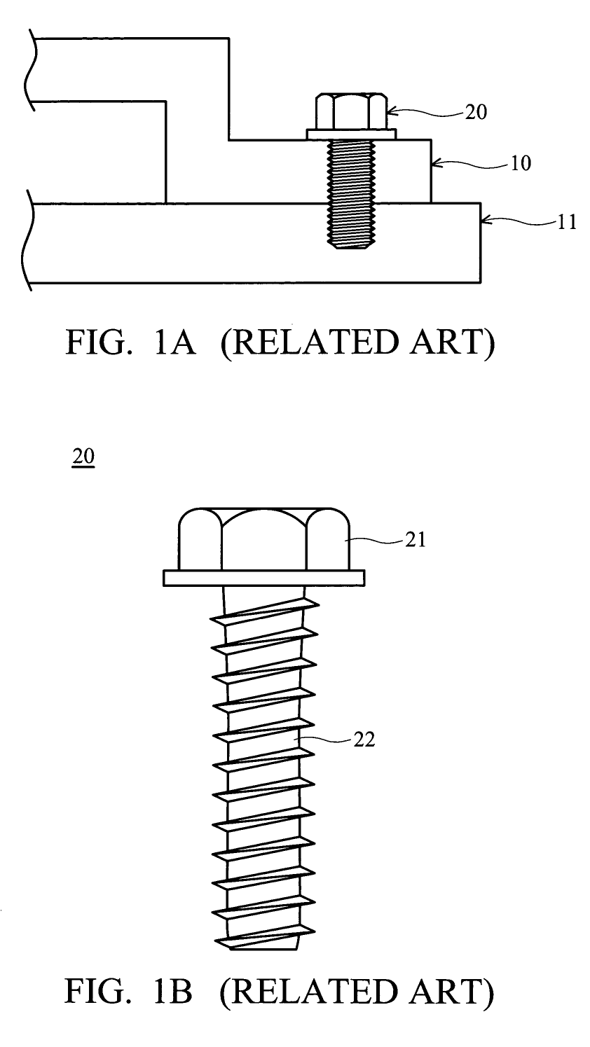

### DETAILED DESCRIPTION

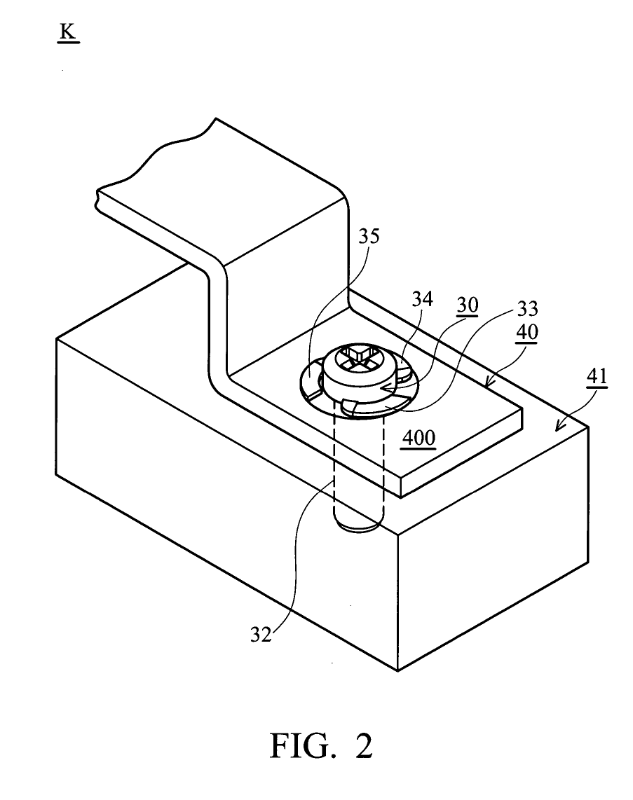

In FIG. 2, an assembled structure K of the invention has a bolt structure 30, a first object 40 and a second object 41. In this preferred embodiment, the first object 40 is a carrier plate and the second object 41 is a base plate, and the bolt structure 30 is made of metal or plastic. As the first object 40 is fastened to the second object 41, the bolt structure 30 acts as a connecting device projecting through the first object 40 and the second object 41, the first object 40 is fixed to the second object 41 by the bolt structure 30, and vice versa.

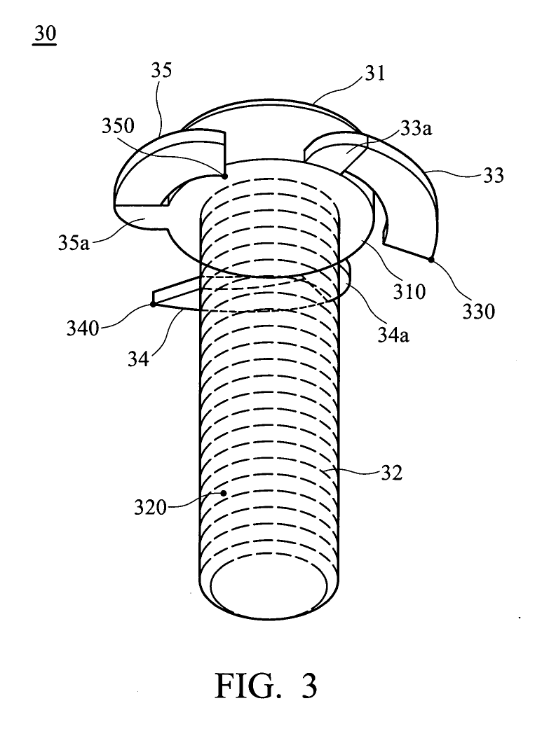

In FIG. 3, 4A and 4B, the bolt structure 30 has a first main body 31, a second main body 32 and three cantilevered portions 33, 34 and 35. The first main body 31 is a head of the bolt structure 30 and provides a base surface 310. The second main body 32 is a rod of the bolt structure 30, disposed on the first main body 31 provided with an outer threaded portion 320 helically formed thereon. The base surface 310 is a shoulder formed between the first main body 31 and the second main body 32. The cantilevered portions 33, 34 and 35 extend outward and helically from the base surface 310 of the first main body 31, respectively, and each of which has same geometric structure symmetrically disposed on the first main body 31. A thickness of the cantilevered portions 33, 34 and 35 is indicated by a symbol “t”. The head. 31, the rod 32 and the cantilevered portions 33, 34 and 35 are integrally formed.

The cantilevered portion 33 has a connecting segment 33a connected to the first main body 31 and a blade segment 33b connected to the connecting segment 33a. The cantilevered portion 34 has a connecting segment 34a connected to the first main body 41 and a blade segment 34b connected to the connecting segment 34a. The cantilevered portion 35 has a connecting segment 35a connected to the first main body 41 and a blade segment 35b connected to the connecting segment 35a.

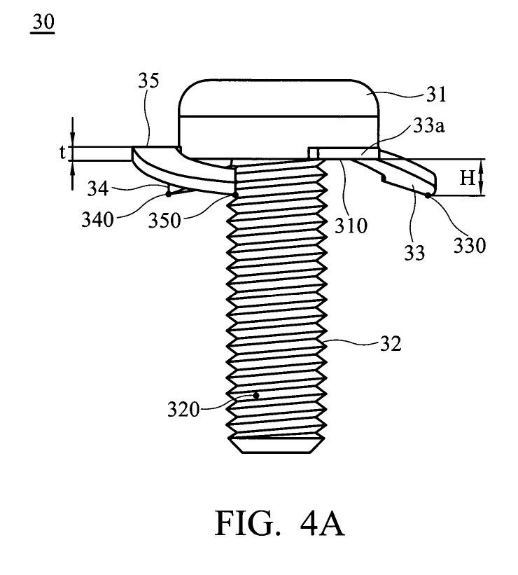

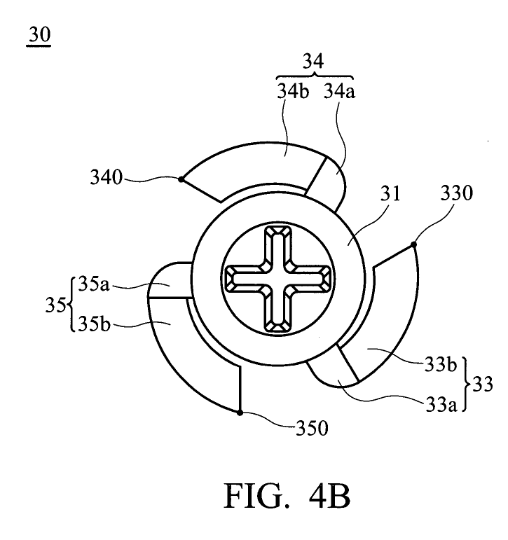

The blade segment 33b is a free end of the cantilevered portion 33 having a distal end 330 thereon. The blade segment 34b is a free end of the cantilevered portion 34 having a distal end 340 thereon. The blade segment 35b is a free end of the cantilevered portion 35 having a distal end 350 thereon. In FIG. 4A, from the distal end 330 of the blade segment 33b to the base surface 310 of the first main body 31, from the distal end 340 of the blade segment 34b to the base surface 310 of the first main body 31, and from the distal end 350 of the blade segment 35b to the base surface 310 of the first main body 31, a predetermined distance “H” is measured along the longitudinal direction of the second main body 32.

When fastening the bolt structure 30 through the first object 40 and the second object 41, as shown in FIG. 2, the cantilevered portions 33, 34 and 35 of the bolt structure 30 uniformly and flexibility contact the first object 40, and each distal end 330, 340, 350 of the cantilevered portions 33, 34 and 35 are substantially embedded on the surface of the first object 40. Thus, the rod 32 of the bolt structure 30 is prevented from rotating under vibration, i.e., the bolt structure 30 is firmly fixed on the first object 40 and the second object 41. It is preferable that the cantilevered portions 33, 34 and 35 of the bolt structure 30 are harder than the first object 40.

Additionally, the assembled object or structure with a bolt structure or a connecting device increases bonding force therebetween and prevents damage due to any vibration or unexpected collision, particularly for a high frequency and directional vibration environment.

While the invention has been described in connection with what is presently considered to be the most practical and preferred embodiment, it is to be understood that the invention is not limited to the disclosed embodiments, but, on the contrary, is intended to accommodate various modifications and equivalent arrangements included within the spirit and scope of the appended claims.

1. A bolt structure, comprising:
a head having a base surface;
a rod connected to the head; and
a cantilevered portion disposed on the head, extending from the base surface of the head by a predetermined distance.

2. The bolt structure as claimed in claim 1, wherein the cantilevered portion has a blade segment and a connecting segment, which is disposed between the head and the blade segment.

3. The bolt structure as claimed in claim 1, wherein the cantilevered portion further comprises a distal end spaced apart from the base surface of the head by the predetermined distance.

4. The bolt structure as claimed in claim 1, wherein the rod has a threaded portion helically extending along a direction opposite to the direction of the cantilevered portion.

5. The bolt structure as claimed in claim 1, wherein the head, the rod and the cantilevered portion are integrally formed.

6. The bolt structure as claimed in claim 1, wherein the bolt structure is made of metal or plastic.

7. The bolt structure as claimed in claim 1 further comprising a plurality of cantilevered portions respectively extending from the base surface of the head and uniformly spaced.

8. A connecting device for connecting a first object to a second object, comprising:
a first main body having a base surface;
a second main body disposed on the first main body for fastening the first object and the second object; and
a cantilevered portion disposed on the first main body, extending from the base surface of the first main body by a predetermined distance and making contact with the first object or the second object as the first object and the second object are connected to each other.

9. The connecting device as claimed in claim 1, wherein the cantilevered portion is harder than the first object.

10. The connecting device as claimed in claim 8, wherein the second main body has a threaded portion helically extending along a direction opposite to the direction of the cantilevered portion.

11. The connecting device as claimed in claim 8, wherein the first main body, the second main body, and the cantilevered portion are integrally formed.

12. The connecting device as claimed in claim 8, wherein the connecting device is made of metal or plastic.

13. The connecting device as claimed in claim 8 further comprising a plurality of cantilevered portions respectively extending from the base surface of the first main body and uniformly spaced.

14. The connecting device as claimed in claim 8, wherein the cantilevered portion has a blade segment and a connecting segment, which is disposed between the first main body and the blade segment.

15. The connecting device as claimed in claim 14, wherein the blade segment of the cantilevered portion further comprises a distal end spaced apart from the base surface of the first main body by the predetermined distance.

16. An assembled structure, comprising:
a first object;
a second object; and
a connecting device for connecting the first object to the second object, comprising a first main body having a base surface, a second main body disposed on the first main body for fastening the first object and the second object, and a cantilevered portion disposed on the first main body and extending from the base surface of the first main body by a predetermined distance, wherein the cantilevered portion makes contact with the first object or the second object as the first object and the second object are connected to each other.

17. The assembled structure as claimed in claim 16, wherein the second main body has a threaded portion helically extending along a direction opposite to the direction of the cantilevered portion.

18. The assembled structure as claimed in claim 16 further comprising a plurality of cantilevered portions respectively extending from the base surface of the first main body and uniformly spaced.

19. The assembled structure as claimed in claim 16, wherein the cantilevered portion has a blade segment and a connecting segment disposed between the first main body and the blade segment.

20. The assembled structure as claimed in claim 19, wherein the cantilevered portion has a distal end spaced apart from the base surface of the first main body by the predetermined distance.
